(19) United States
(12) Patent Application Publication
(10) Pub. No.: US 2007/0147410 A1
(43) Pub. Date: Jun. 28, 2007

(54) Detecting wireless devices to inform about a quiet period

(75) Inventor: Nishant Kumar, San Diego, CA (US)

Correspondence Address: VAN PELT, YI & JAMES LLP, 10050 N. FOOTHILL BLVD #200, CUPERTINO, CA, 95014, US

(73) Assignee: Staccato Communications, Inc.

(21) Appl. No.: 11/606,790

(22) Filed: Nov. 29, 2006

Related U.S. Application Data
(60) Provisional application No. 60/740,842, filed on Nov. 29, 2005.

(51) Int. Cl. H04L 12/28

(52) U.S. Cl. 370/431

(57) ABSTRACT

A wireless device is detected. A signal is received via a wireless medium. The received signal is processed to detect a wireless device, if any, to communicate with regarding a quiet period. During the quiet period, wireless devices that are aware of the quiet period refrain from transmitting, and the device performing the technique is operating on a first physical channel and the wireless device being detected is associated with a second physical channel. In the event a wireless device is detected, information associated with the detection is forwarded.

### CROSS REFERENCE TO OTHER APPLICATIONS

This application claims priority to U.S. Provisional Patent Application No. 60/740,842 entitled POWER DETECTION FOR DETECTION AND AVOIDANCE filed Nov. 29, 2005 which is incorporated herein by reference for all purposes.

### BACKGROUND OF THE INVENTION

In a wireless environment, devices must share the wireless medium. To ensure that wireless devices are able to operate at an acceptable level of performance, some wireless devices include detection and avoidance capabilities. For example, it may be required or desirable for ultra wideband (UWB) devices (one type of which is described in the WiMedia UWB specification) to include capabilities to detect and avoid other wireless devices, such as narrowband WiMax devices.

Some techniques for detecting wireless devices that are being interfered with include the use of quiet periods. During a quiet period, one or more wireless devices (e.g., a group of WiMedia UWB devices) refrain from transmitting and use the quiet period to detect other wireless devices, if any, that are being interfered with (e.g., a WiMax device being interfered with). In some cases, it is desirable to have another group of wireless devices (e.g., operating on another physical channel) also respect a quiet period. Techniques to detect the presence of wireless devices to be communicated with regarding a quiet period may be desirable.

### BRIEF DESCRIPTION OF THE DRAWINGS

Various embodiments of the invention are disclosed in the following detailed description and the accompanying drawings.

FIG. 1 illustrates a scenario in which a quiet period is used to detect a wireless terminal that is being interfered with.

FIG. 2 is a diagram illustrating an example of a quiet period.

FIG. 3 is a diagram illustrating two examples of physical channels.

FIG. 4 is a block diagram illustrating an embodiment of a wireless device includes a variety of components associated with detecting the presence of an adjacent logical channel device.

FIG. 5 is a diagram illustrating an embodiment of data output by an ADC.

FIG. 6 is a flowchart illustrating an embodiment of a detection process, including determining the physical channel used by the detected wireless device(s).

FIG. 7A is a diagram illustrating an embodiment in which a wireless device is operating on a physical channel that includes three bands.

FIG. 7B is a diagram illustrating an embodiment in which a wireless device is detected and the detected wireless device is operating in a band hopping mode.

FIG. 7C is a diagram illustrating an embodiment in which a wireless device is detected and the detected wireless device uses a fixed frequency interleaving (FFI) physical channel.

FIG. 8 is a diagram illustrating an embodiment of an analog power detection technique that processes a portion of a frequency spectrum.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

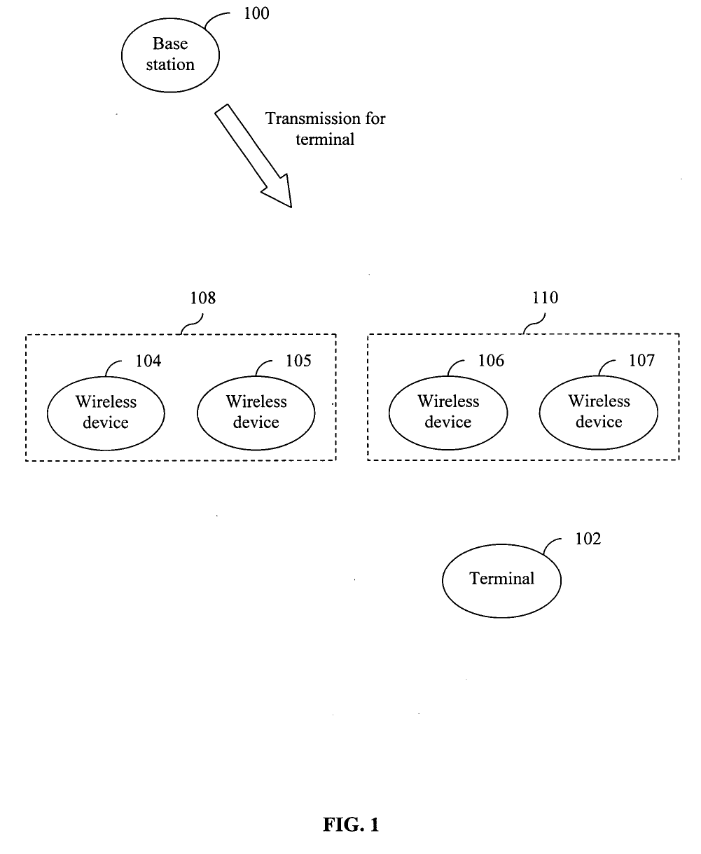

FIG. 1 illustrates a scenario in which a quiet period is used to detect a wireless terminal that is being interfered with. In the example shown, terminal 102 and base station 100 communicate with each other according to the WiMax wireless specification. Terminal 102 is located relatively far from base station 100 and is located relatively close to wireless devices 104-107. In this example, wireless devices 104-108 are ultra wideband (UWB) devices, such as a WiMedia UWB device. The bandwidth of a WiMedia UWB signal is much larger than that that of a WiMax signal (e.g., 528 MHz compared to 10 or 20 MHz) and the large bandwidth of UWB signals may interfere with the signal received by terminal 102.

Terminal 102 is configured to operate according the WiMax specification and transmits only when certain transmissions are received from base station 100. Because terminal 102 is located so far away from base station 100, interference from wireless devices 104-107 may contribute to terminal 102 being unable to properly receive transmissions from base station 100, thus preventing terminal 102 from transmitting. However, if terminal 102 does not transmit, wireless devices 104-107 may be unable to detect terminal 102 and would not know to perform avoidance measures. To avoid this undesirable scenario from occurring, wireless devices 104-107 use a quiet period to detect terminal 102. The following figure illustrates one example of a quiet period.

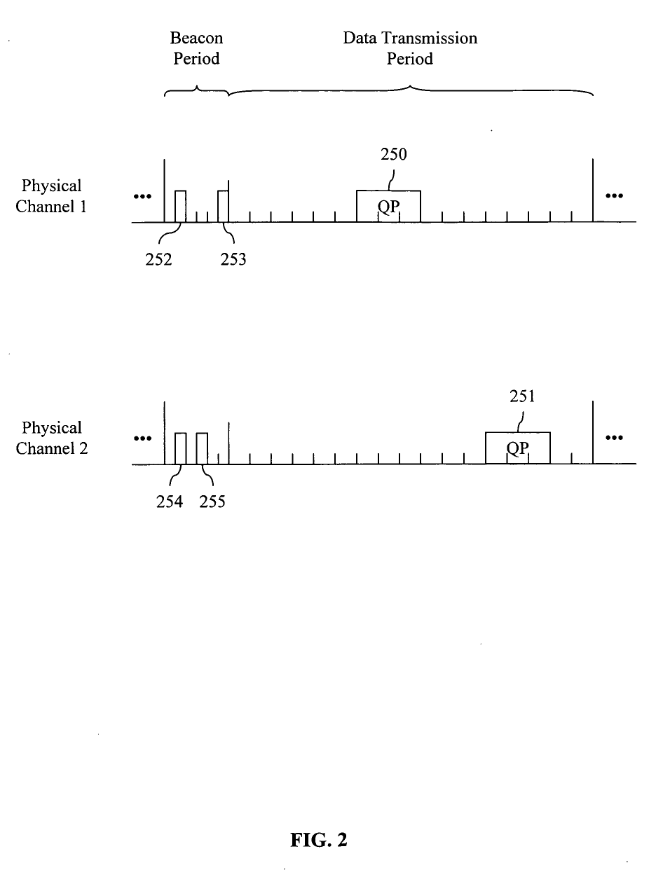

FIG. 2 is a diagram illustrating an example of a quiet period. In the example shown, time on a given physical channel is divided into superframes. Wireless devices 104-107 are associated with two groups: group 108 (which includes wireless devices 104 and 105) and group 110 (which includes wireless devices 106 and 107). Group 108 operates on physical channel 1 and group 110 operates on physical channel 2. In this example, one superframe is shown for physical channel 1 and one superframe is shown for physical channel 2. In some cases, the superframes associated with physical channels 1 and 2 do not necessarily align. That is, the beacon period start time (i.e., the start of a superframe) on physical channel 1 does not necessarily match the beacon period start time on physical channel 2.

A superframe is divided into a beacon period and a data transmission period. Each wireless device is required to transmit a beacon every beacon period. For example, on physical channel 1, wireless devices 104 and 105 transmit beacons 252 and 253, respectively. Similarly, on physical channel 2, wireless devices 106 and 107 transmit beacons 254 and 255, respectively.

In the example shown, quiet period 250 is used by wireless devices 104-105 of FIG. 1 to detect terminal 102. During a quiet period, wireless devices that are aware of the quiet period do not transmit. For example, wireless devices 104 and 105 are aware of quiet period 250 and do not transmit during that time. A terminal (e.g., terminal 102) is able to receive a transmission during a quiet period from a base station (e.g., base station 100), thus permitting the terminal to transmit. The transmission by the terminal is detected by one or more wireless devices and appropriate avoidance measures can be taken. Some examples of avoidance techniques include creating a notch, changing the physical channel, etc.

In the example shown, quiet period 251 does not align with quiet period 250 and it is desirable for the two quiet periods to be aligned so that wireless devices 104-107 are quiet at the same time. In one example of how the situation shown may have resulted, groups 108 and 110 may have been started in isolation from each other. After quiet periods 250 and 251 were established, groups 108 and 110 may have been brought into proximity of each other. In some embodiments, a new quiet period is established on physical channel 2 that is overlaps with quiet period 250 and quiet period 251 is kept where it is.

What is disclosed is the detection of a wireless device, if any, that is informed or otherwise communicated with regarding a quiet period. For example, wireless devices 104 and/or 105 of group 108 may perform such a process to detect wireless devices 106 and/107. Once detected, in some embodiments the presence and/or characteristics of a detected wireless device or a detected group of wireless devices are passed to an appropriate process or entity responsible for communicating with the other group about quiet periods. For example, if wireless device 104 detects wireless device 106 and/or 107, a signal indicating that other wireless devices have been located may be passed to a communication module in wireless device 104 to communicate with wireless device 106 and/or 107 as needed so that quiet periods 250 and 251 align. Any appropriate communication module and/or technique may be used. For example, in some embodiments, a beacon or other control/management frames is sent on physical channel 2 to be received by wireless devices 104 and 105, eventually causing quiet periods 250 and 250 to be aligned. In some embodiments, the physical channel used by wireless device 106 and/107 (i.e., physical channel 2) is also passed to such communication module, for example so that a communication module knows which physical channel to communicate on or otherwise use.

In some embodiments, a physical channel or band is monitored while a wireless device is operating in its operational physical channel. For example, if a detection process is performed by wireless device 104 or 105, that device may continue to operate in physical channel 1 while monitoring physical channel 2. In some applications this is desirable since, for example, traffic is able to be exchanged on the operational physical channel while detecting other wireless devices. It may be unattractive for a data rate or throughput to drop while detecting other wireless devices. Other applications may have other constraints or desired performance considerations and a detecting wireless device in other embodiments may not necessarily be so configured.

In some embodiments, a process to detect a wireless device to be communicated with regarding a quiet period is not necessarily concerned with whether or not the other wireless device is already aware of the quiet period. For simplicity, some detection processes simply detect all other wireless devices (e.g., that are not on the detecting wireless device's physical channel) and detected devices are repeatedly communicated with regarding a quiet period.

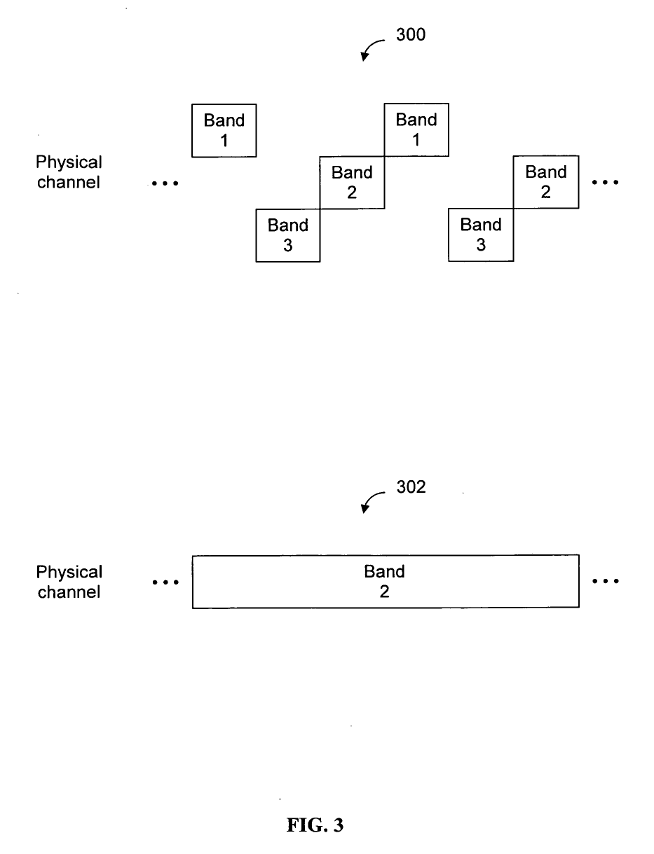

FIG. 3 is a diagram illustrating two examples of physical channels. In the example shown, physical channel 300 is associated with band hopping where a hop pattern repeated. The WiMedia UWB specification permits the use of band hopping, which is also referred to as Time Frequency Interleaving (TFI). The WiMedia UWB specification and other specifications define permitted hop patterns. The hop pattern in physical channel 300 is (band 1, band 3, band 2) and this hop pattern is repeated. Bands 1, 2, and 3 (used in physical channel 300) do not overlap in frequency in this example. In some embodiments, bands and/or physical channels vary from these examples. For example, bands may overlap in frequency, or some other hop pattern and/or number of bands is used.

In various embodiments, the amount of time spent on a band varies. For example, in the WiMedia UWB specification, the amount of time spent on each band corresponds to the duration of an Orthogonal Frequency Division Multiplexing (OFDM) symbol. In some embodiments, some other duration of time is spent on a given band. For example, a wireless device may transmit a frame or a packet on a given band and then change to another band.

Physical channel 302 comprises of a single band (i.e., band 2). The WiMedia UWB specification permits the use of a physical channel with a single band and refers to it as Fixed Frequency Interleaving (FFI).

Table 1 shows bands and band groups defined by the WiMedia UWB specification. In WiMedia UWB, bands are non-overlapping frequency ranges that are identified by a band ID. A band group includes two or more bands.

TABLE 1
WiMedia UWB Bands

| | | Center |
|---|---|---|
| Band Group | Band ID | Frequency |
| 1 | 1 | 3.432 GHz |
| | 2 | 3.960 GHz |
| | 3 | 4.488 GHz |
| 2 | 4 | 5.016 GHz |
| | 5 | 5.544 GHz |
| | 6 | 6.072 GHz |
| 3 | 7 | 6.600 GHz |
| | 8 | 7.128 GHz |
| | 9 | 7.656 GHz |
| 4 | 10 | 8.184 GHz |
| | 11 | 8.712 GHz |
| | 12 | 9.240 GHz |
| 5 | 13 | 9.768 GHz |
| | 14 | 10.296 GHz |
| 6 | 9 | 7.656 GHz |
| | 10 | 8.184 GHz |
| | 11 | 8.712 GHz |

In the WiMedia UWB specification, physical channels associated with band hopping use bands from a single band group. For example, a physical channel in WiMedia UWB would not be permitted to include bands 1, 2, and 4 since bands 1 and 2 are associated with band group 1 and band 4 is associated with band group 2.

Wireless device(s) to be communicated with regarding quiet periods are detected in a variety of ways in various embodiments. The following figures illustrate some embodiments where a digital energy detector and an analog power detector are used, respectively, to detect other wireless devices.

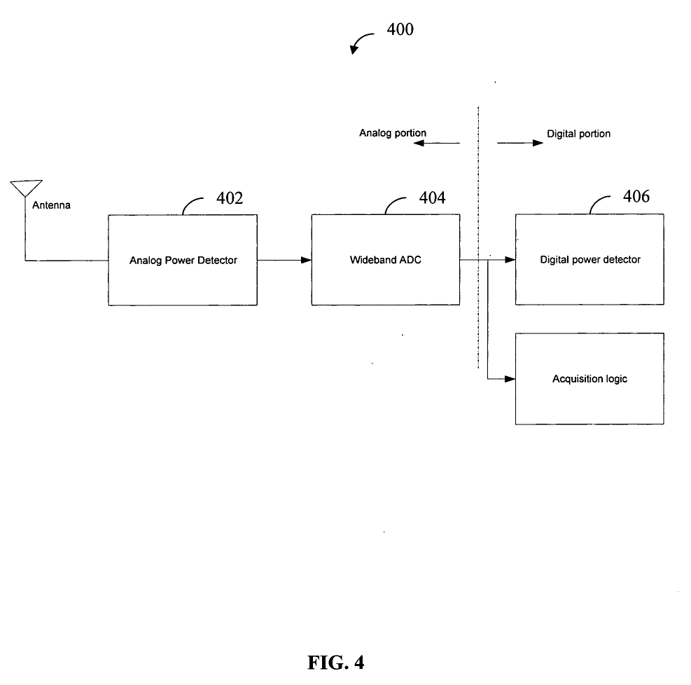

FIG. 4 is a block diagram illustrating an embodiment of a wireless device includes a variety of components associated with detecting the presence of an adjacent logical channel device. In the example shown, wireless device 400 includes analog power detector 402, located before wideband ADC 404. Analog power detector 402 in some embodiments is configured t operate at RF an in some embodiments is configured to operate analog base-band.

In some embodiments, wireless device uses wideband ADC 404 to detect an adjacent logical channel device. Wideband ADC 404 may have a bandwidth that is much wider that that needed to operate on a logical channel (e.g., approximately two times the width of a band or logical channel). An example of this is presented in further detail below.

In some embodiments, digital power detector 406 is used to detect an adjacent logical channel device. For example, in some embodiments where digital power detector 406 is used to detect an adjacent logical channel device, an ADC converter of 528 MHz may be used. The radio is configured to hop in a certain way and the energy in each band is monitored in order to determine the presence of an adjacent channel device. This type of detection is done when the detecting wireless device knows or otherwise expects no communication to occur in its own logical channel. This is similar to analog power detector 402 but instead of employing an analog power detector, a digital detector is used. In some applications, using digital power detector 406 is attractive because in some cases a significant amount of power is saved compared to a regular CCA (acquisition), since the only digital circuitry needed to be toggling (i.e., on) is related to energy accumulation which has relatively fewer gates compared to full acquisition.

In some embodiments, power detection is performed in the digital domain and/or using an analog to digital converter (ADC) with a bandwidth greater than that of an operational band or physical channel. The following figure illustrates an embodiment for using an ADC to perform power detection.

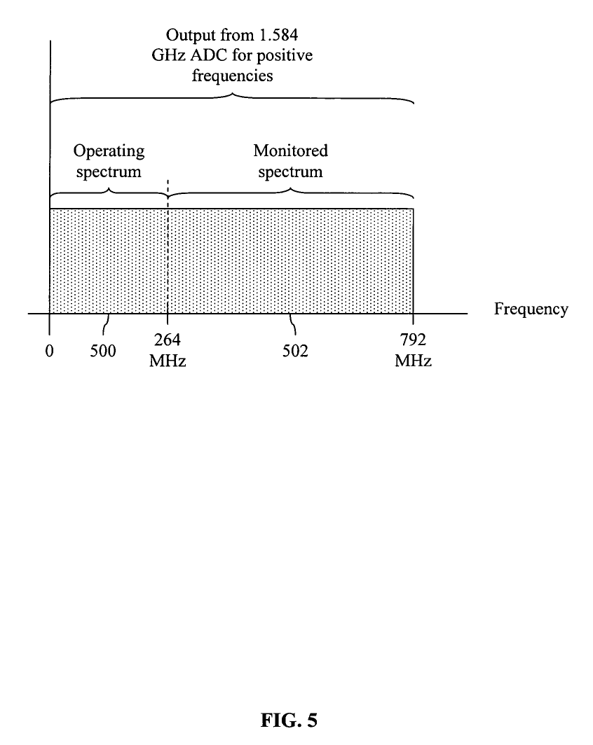

FIG. 5 is a diagram illustrating an embodiment of data output by an ADC. In the example shown, the ADC has an operating frequency or bandwidth of 1.584 GHz. The data shown may have been stepped down in frequency from a higher carrier frequency. Referring to Table 1, band 1 (as an example) has a center frequency of 3.432 GHz and the received signal may have been stepped down from a carrier frequency of 3.432 GHz if band 1 (or a physical channel that includes band 1) is used.

In this example, only the positive frequencies are shown. Since the ADC in this example is operating at 1.584 GHz, the positive frequencies correspond to 0-792 MHz. In this example, the WiMedia UWB specification is implemented where a band is 528 MHz wide. Operating spectrum 500 (i.e., 0-264 MHz) is used to exchange information with other wireless devices in the group. Note that only the positive frequencies are shown, so some information is carried in the negative frequency range of −264 MHz to 0, corresponding to a band with a width of 528 MHz.

Monitored spectrum 502 (i.e., 264 MHz-792 MHz) corresponds to a frequency range that is monitored or otherwise processed for the presence of other wireless devices. For example, if operating spectrum 500 corresponds to band 1 (e.g., because the physical channel is a FFI physical channel on band 1, or is a TFI channel that is currently on band 1), then monitored spectrum 502 corresponds to band 2.

In one example of how information in monitored spectrum 502 is processed, a digital filter is applied so that information in monitored spectrum 502 is selected. The filtered output is integrated to determine if there is energy present in monitored spectrum 502. In some embodiments, a threshold is used where if the energy level is greater than the threshold it is determined there is a wireless device operating in monitored spectrum 502.

The spectrums and widths shown in this figure are merely exemplary and are used to illustrate the technique. For example, other types of wireless specifications may use physical channels or bands with different widths and such embodiments may use different values.

In some embodiments, using an ADC is desirable since it does not require the use of addition components, such as an additional local oscillator (e.g., to tune to another physical channel). In other applications, the constraints, considerations, and/or desired performance associated with a particular application may vary from the above example, and some other embodiment (e.g., that does not include an ADC) is used for that application. Some example considerations include power consumption, an amount of time to detect a wireless device (e.g., nominal or worst case), etc.

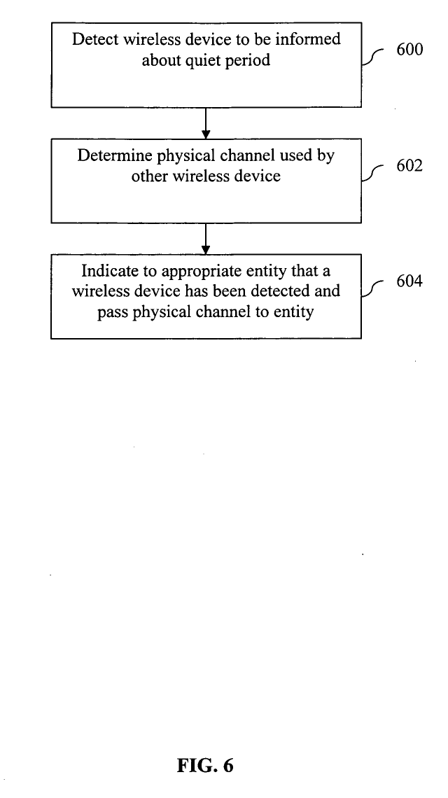

FIG. 6 is a flowchart illustrating an embodiment of a detection process, including determining the physical channel used by the detected wireless device(s). For example, if the process is performed by wireless device 104 in FIG. 1, the physical channel used by wireless devices 106 and 107 is determined. Alternatively, in some embodiments the physical channel used by a detected wireless device is not determined.

At 600, a wireless device to be informed about quiet period is detected. In some embodiments, an analog power detector is used. In some embodiments, an energy detector is used.

The physical channel used by the other wireless device is determined at 602. In some embodiments, certain results or values indicate that a particular physical channel is being used. In some embodiments, a list of permitted physical channels associated with wireless devices of interest is used. Some examples are discussed in further detail below.

At 604, it is indicated to an appropriate entity that a wireless device has been detected and the physical channel is passed to the entity. For example, the indication and physical channel determined may be passed to a communication module responsible for communicating with the other wireless device about the quiet period. In some embodiments, a beacon is generated with quiet period information as a result of the indication and is transmitted on the physical channel determined at 602.

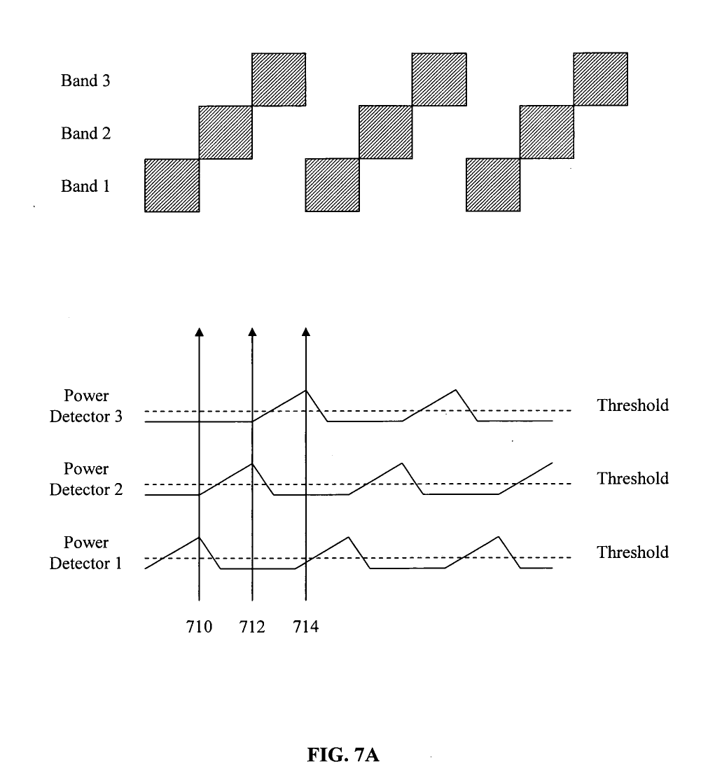

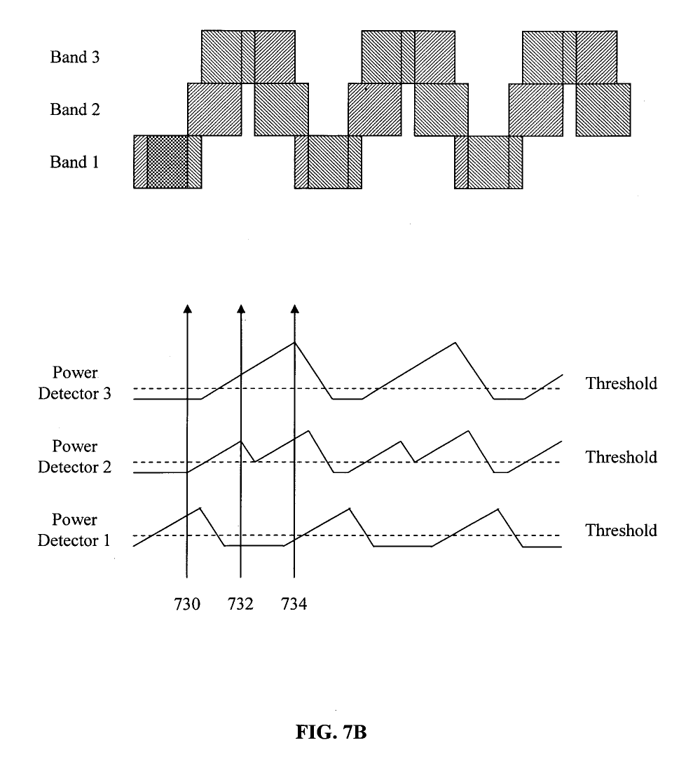

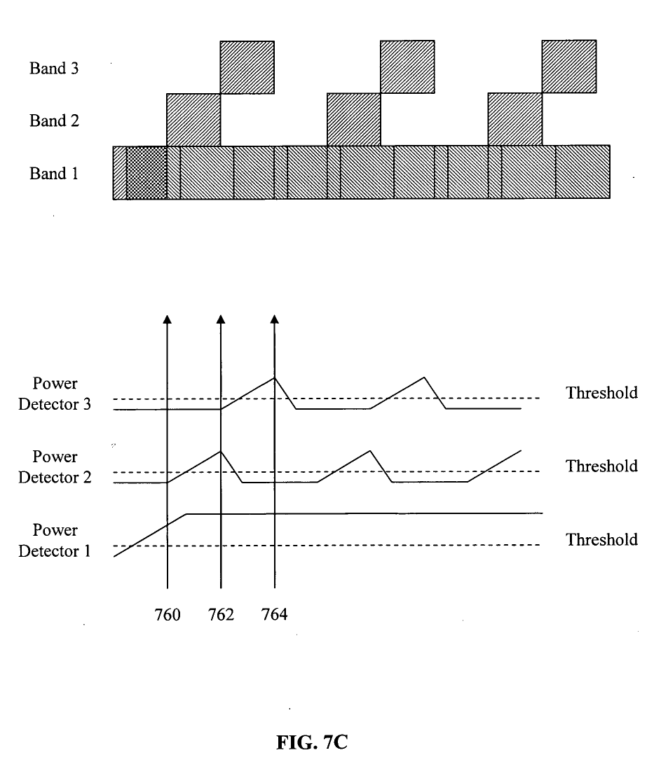

FIG. 7A is a diagram illustrating an embodiment in which a wireless device is operating on a physical channel that includes three bands. In the example shown, the physical channel has a hop pattern of (band 1, band 2, band 3). Three power detectors are operating in bands 1-3 and their outputs are shown. At times 710, 712, and 714, the outputs of all three power detectors are sampled. The sample times 710, 712, and 714 correspond to the symbol boundaries. At sample time 710, only the output of power detector 1 is above the threshold. At sample time 712, power detector 2 is the only one with an output greater than the threshold. Similarly, at sample time 714, power detector 3 is the only one with an output greater than the threshold.

This figure shows one example in which a wireless device or group of wireless devices is operating alone. For example, wireless devices 104 and 105 may be operating alone and wireless devices 106 and 107 are not in range. Based on the outputs of the power detectors shown, it is determined that there are no other wireless devices.

In this figure and the following figures, the outputs of all three power detectors are shown at all times for clarity. In actuality, some embodiments may not necessarily have three power detectors and/or a given power detector may not necessarily be operating constantly on a given band. For example, to save power and/or reduce the number of components in a wireless device, there may be a single power detector (e.g., that stays on a single band or periodically changes to a new band).

FIG. 7B is a diagram illustrating an embodiment in which a wireless device is detected and the detected wireless device is operating in a band hopping mode. In the example shown, two groups of wireless devices are operating in proximity of each other. For example, a new group of wireless devices may have entered the vicinity of the wireless device(s) operating in the example of FIG. 7A. The group of wireless devices performing the detection process uses a hop pattern of (band 1, band 2, band 3). Symbols for that group are shown with diagonal lines running from bottom-left to top-right. The other group of wireless devices uses a hop pattern of (band 1, band 3, band 2). Symbols for that group are shown with diagonal lines running from top-left to bottom-right. The timing of the two groups is not aligned and the symbol boundaries do not match up.

At sampling time 730, the output of power detector 1 is the only output of the three power detectors that is greater than the threshold. This is expected since the wireless device performing the detection process is currently on band 1. At sampling time 732, the outputs of power detectors 2 and 3 are greater than the threshold. This indicates that there is another wireless device operating in the vicinity of the detecting wireless device, and that the wireless device is on band 3 at this time. At sampling time 734, the outputs of power detectors 2 and 3 are greater than the threshold. Since the output of power detector 2 is greater than the threshold this indicating that there is another wireless device operating on band 2 at this time.

By sampling the power detector outputs, the physical channel used by the other wireless device(s) may be determined. For example, using the outputs at sampling times 732 and 734, it may be inferred that the hop pattern for the other wireless device includes bands 3 and 2, in that order. Since only the output of power detector 1 at sampling time 730 is greater than the threshold, it may be inferred that the other wireless device is also on band 1 at that time. Thus, it is determined that the detected wireless device uses a physical channel with a hop pattern of (band 1, band 3, band 2) and this information is passed to an appropriate module or entity in some embodiments. In some embodiments, a list of permitted physical channels or permitted hop patterns is used in determining a physical channel used.

In some embodiments, outputs of an analog power detector or other signal processor are not necessarily sampled only at certain points in time. That is, in some embodiments, outputs from an analog power detector at all points in times are examined or are otherwise used. For example, a peak in an analog power detector output that does not correspond to a symbol boundary of the detecting wireless device may indicate the presence of another wireless device. In this figure, the output of analog power detector 1 has a local peak that occurs between sampling times 730 and 732 and this may indicate the presence of another wireless device.

Sampling results may be stored as appropriate and then retrieved to identify the physical channel being used by another wireless device. For example, in some embodiments a table is used, such as the following example table.

TABLE 2
Example table of whether power detector outputs are greater than
a threshold

| | Sampling | Sampling | Sampling |
|---|---|---|---|
| | time 730 | time 732 | time 734 |
| Power | No | Yes | Yes |
| Detector 3 | | | |
| Power | No | Yes | Yes |
| Detector 2 | | | |
| Power | Yes | No | No |
| Detector 1 | | | |

Alternatively, in some embodiments, only times and bands at which a power detector output is greater than a threshold (or other criterion) are stored.

In some embodiments, the outputs of a power detector do not as clearly identify the particular physical channel compared to this example. For example, suppose that at certain times the other wireless device has a weak signal and the output of power detector 3 at time 732 did not exceed the threshold. If at some subsequent time when the other wireless device is operating on band 3 (i.e., 3 symbol durations after time 732, 6 symbol durations after time 732, etc.), the output of power detector 3 is greater than the threshold, that result may be consistent with a physical channel having a hop pattern of (band 1, band 3, band 2) and the physical channel is so identified. For example, example table 2 from above may be extended so that more points in time are recorded, and points in time that correspond to each other for a given power detector are OR'd together. For example, for power detector 3, the results at time 732 are OR'd with that for the time 3 symbol durations after time 732 and with that for the time 6 symbol durations after time 732.

FIG. 7C is a diagram illustrating an embodiment in which a wireless device is detected and the detected wireless device uses a fixed frequency interleaving (FFI) physical channel. As in the previous example, the wireless device performing the detection process uses a band hopping physical channel with a hop pattern of (band 1, band 2, band 3).

At sampling time 760, the output of power detector 1 is the only power detector output greater than the threshold. At sampling time 762, the outputs of power detectors 1 and 2 are both greater than the threshold. At sampling time 764, the outputs of power detectors 1 and 3 are greater than the threshold.

Since the wireless device performing the detection process is using a physical channel with a hop pattern of (band 1, band 2, band 3), the output of power detectors 1 at sampling times 762 and 764 indicate that there is another wireless device operating in the vicinity of the detecting wireless device, and that the detected wireless device is using a physical channel of band 1.

In some cases, it may be difficult to build an analog power detector capable of processing certain bandwidths. For example, in the case of WiMedia UWB, each band is 528 MHz wide and analog power detectors that operate over 528 MHz may be difficult to develop. The following figure illustrates an embodiment of an analog power detection process that may be used in scenarios such as this.

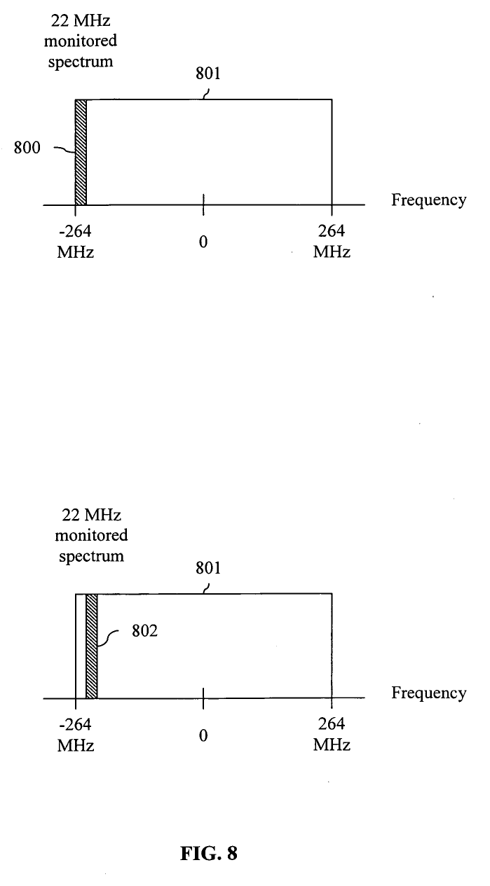

FIG. 8 is a diagram illustrating an embodiment of an analog power detection technique that processes a portion of a frequency spectrum. In this example, band 801 corresponds to a WiMedia band and is 528 MHz wide. Portion 800 is 22 MHz wide and corresponds to the frequency range of −264 MHz thru −242 MHz. In this example, the analog power detector is configured to receive and/or operate only on data received in portion 800 of band 801 for some period of time.

After processing data in portion 800 for some period of time, the analog power detector processes data in portion 802 for some period of time. For example, the analog power detector may be configured differently or data that is passed to the analog power detector may be switched from data associated with portion 800 to portion 802. In some embodiments, the same amount of time is spent receiving or processing data from portions 800 and 802. In some embodiments, a non-equal amount of time is spent in each portion. In some embodiments, band 801 is divided into 24 adjacent portions, each portion of which is 22 MHz wide and an analog power detector goes through each portion.

By periodically changing a portion of a band processed by an analog power detector, it may be possible to detect a wireless device that uses a larger bandwidth (e.g., 528 MHz) using an analog power detector with a smaller bandwidth (e.g., 22 MHz). As mentioned previously, this may be attractive in some scenarios, for example if analog power detectors with narrower widths or frequency ranges are easier to develop or less expensive to use.

In some embodiments, to ensure that a false alarm is not triggered, one or more criteria must be satisfied in order for it to be determined that a wireless device has been detected. Some example criterion include a minimum number of monitored spectrum in which power is detected and/or a minimum number of adjacent monitored spectrum in which power is detected. For example, the detection process may be performed by a UWB device and the device is interested in detecting other UWB devices to communicate with regarding a quiet period. The detecting wireless device may not necessarily be interested in, for example, detecting a narrowband wireless device (e.g., an IEEE 802.11 device or a WiMax device) if those devices will not be communicated with regarding the quiet period. For example, if the example configuration is used and 10 out of 24 portions are found to have analog power, it may be determined there is a wireless device operating in that band. Conversely, if only 1 out of 24 portions have analog power, then it may be determined there is no wireless device. In some embodiments, a threshold (e.g., a number of portions or a percentage) is used. In some embodiments, analog power detection ends or terminates without processing all portions. A process may end, for example, if the process has reached some conclusion or determination to a satisfactory degree where additional data from the remaining portions is not needed and will not affect the determination.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for detecting a wireless device, comprising:
receiving a signal via a wireless medium;
processing the received signal to detect a wireless device, if any, to communicate with regarding a quiet period, wherein:
wireless devices that are aware of the quiet period refrain from transmitting during the quiet period; and
the device performing the method is operating on a first physical channel and the wireless device being detected is associated with a second physical channel; and
in the event a wireless device is detected, forwarding information associated with the detection.

2. A method as recited in claim 1, wherein processing includes analog power detection.

3. A method as recited in claim 1, wherein processing includes energy detection.

4. A method as recited in claim 1, wherein processing includes using an analog to digital converter (ADC) that includes an operating spectrum and a monitored spectrum.

5. A method as recited in claim 1, wherein the device performing the method is operating on a first physical channel and the detected wireless device is operating on a second physical channel.

6. A method as recited in claim 1, wherein:
the second physical channel is associated with a band, wherein the band is divided into a plurality of monitored frequency ranges including a first monitored frequency range and a second monitored frequency range;
the received signal is a first received signal associated with the first monitored frequency range and is received during a first period of time;
the method further includes receiving, during a second period of time that does not overlap with the first period of time, a second received signal associated with the second monitored frequency range; and
processing includes considering (1) a result of a detection process applied to the first received signal and (2) a result of a detection process applied to the second received signal in determining if there is a wireless device operating in the band.

7. A method as recited in claim 6, wherein in order for it to be determined that a wireless device has been detected, a number of monitored frequency ranges with a positive detection result must be greater than a threshold number.

8. A method as recited in claim 2, wherein there is a first power detector associated with a first band and a second power detector associated with a second band.

9. A method as recited in claim 2, wherein a given power detector is associated with a first band during a first period of time and is associated with a second band during a second period of time.

10. A method as recited in claim 1, wherein the method further includes identifying the second physical channel associated with the detected wireless device and forwarding includes forwarding the identified second physical channel.

11. A method as recited in claim 1, wherein:
processing includes:
determining whether there is a wireless device operating in a first band at a first set of one or more points in time; and
determining whether there is a wireless device operating in a second band at a second set of one or more points in time.

12. A method as recited in claim 11, wherein at least some of the points in time in the first set and at least some of points in time in the second set are the same points in time.

13. A method as recited in claim 11, wherein the points of time in the first set are associated with symbol boundaries.

14. A method as recited in claim 11, wherein in the event it is determined there is a wireless device operating in the first band at two consecutive points in time, the second physical channel is identified as a fixed frequency interleaving (FFI) channel associated with the first band.

15. A method as recited in claim 11, wherein a plurality of permitted time frequency interleaving (TFI) channels is consulted and in the event it is determined that points in time and corresponding bands at which a wireless device is detected are consistent with one of the plurality permitted TFI channels, the second physical channel is identified as said one of the plurality permitted TFI channels.

16. A system for detecting a wireless device, comprising:
a receiver configured to receive a signal via a wireless medium;
a processor configured to process the received signal to detect a wireless device, if any, to communicate with regarding a quiet period, wherein:
wireless devices that are aware of the quiet period refrain from transmitting during the quiet period; and
the device performing the method is operating on a first physical channel and the wireless device being detected is associated with a second physical channel; and
an interface configured to forward information associated with the detection in the event a wireless device is detected.

17. A computer program product for detecting a wireless device, the computer program product being embodied in a computer readable medium and comprising computer instructions for:
receiving a signal via a wireless medium;
processing the received signal to detect a wireless device, if any, to communicate with regarding a quiet period, wherein:
wireless devices that are aware of the quiet period refrain from transmitting during the quiet period; and
the device performing the method is operating on a first physical channel and the wireless device being detected is associated with a second physical channel; and
in the event a wireless device is detected, forwarding information associated with the detection.
